(19) United States
(12) Patent Application Publication
(10) Pub. No.: US 2013/0146744 A1
(43) Pub. Date: Jun. 13, 2013

(54) MOLD WITH WATER-COOLING CHANNELS

(71) Applicant: HON HAI PRECISION INDUSTRY CO., LTD., New Taipei (TW)

(72) Inventors: YUN-YU CHOU, New Taipei (TW); KO-HUA CHEN, New Taipei (TW)

(73) Assignee: HON HAI PRECISION INDUSTRY CO., LTD., New Taipei (TW)

(21) Appl. No.: 13/690,141

(22) Filed: Nov. 30, 2012

(30) Foreign Application Priority Data
Dec. 8, 2011 (TW) 100145227

(51) Int. Cl. B29C 33/04

(52) U.S. Cl. CPC B29C 33/04
USPC 249/63

(57) ABSTRACT

A mold includes a first mold base, a second mold base, a core and at least one sliding block. The second mold base engages with the first mode base. The core is fixedly positioned in the second mold base. The at least one sliding block is slidably positioned on the second mold base and positioned adjacent to edges of the core. A plurality of first cooling channels is defined in the core. The at least one sliding block and the core cooperatively form a molding space. A second cooling channel is defined in each sliding block.

### BACKGROUND

1. Technical Field

The present disclosure generally relates to molds, and particularly to a mold with water-cooling channels to cool the mold.

2. Description of Related Art

Simply structured cooling channels are formed in a mold to cool the mold. However, cooling can cause problems at the edges of the core of the mold, when molding products have thin walls, because the thin walls may cool non-uniformly, thereby causing warpages formed at edges of the products.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 shows an isometric view of a mold of one embodiment including a first mold base and a second mold base.

FIG. 2 shows a top view of the mold of FIG. 1 without the first mold base.

### DETAILED DESCRIPTION

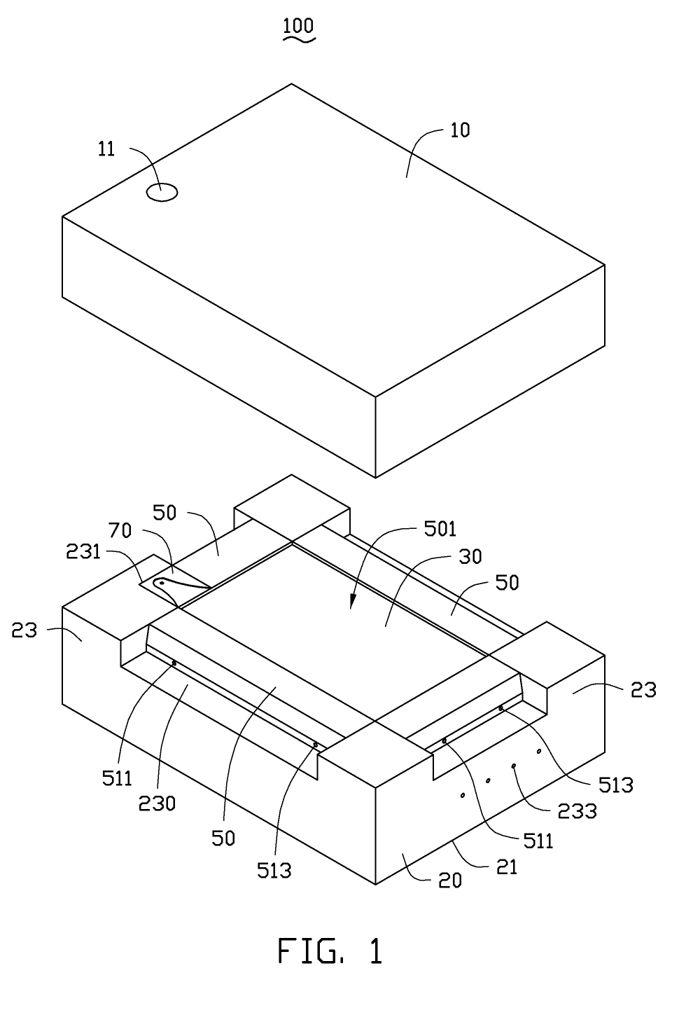

Referring to FIG. 1, one embodiment of a mold 100 for producing optical light guiding plates (not shown) is shown. The mold 100 includes a first mold base 10, a second mold base 20 engaging with the first mold base 10, a core 30, four sliding blocks 50, and a gate inlet block 70. The core 30, the four sliding blocks 50, and the gate inlet block 70 are mounted in the second mold base 20.

The first mold base 10 is substantially rectangular. A main channel 11 is defined in one side of the first mold base 10.

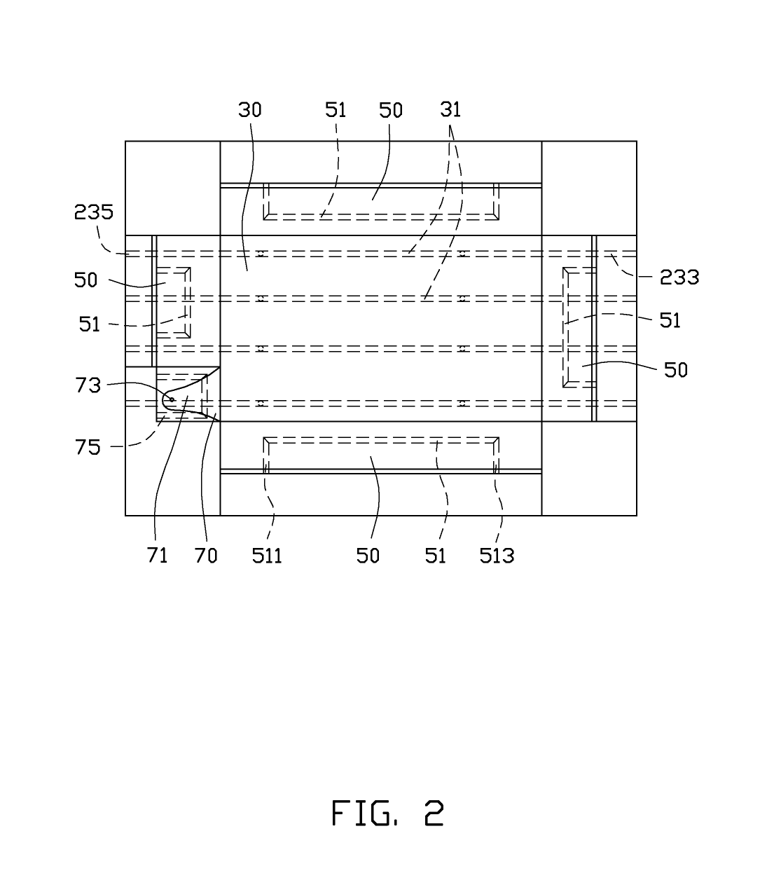

Referring to the FIG. 2, the second mold base 20 includes a bottom wall 21 and four sidewalls 23 substantially perpendicularly extending from edges of the bottom wall 21 along a same direction. The bottom wall 21 and the four sidewalls 23 cooperatively form a substantially rectangular receiving space (not shown). A first receiving groove 230 is defined on a top of each sidewalls 23. The first receiving groove 230 is communicated with the receiving space. A second receiving groove 231 is formed on a top of one of the four sidewalls 23 adjacent to the first receiving groove 230, and is communicated with the first receiving groove 230. A plurality of water inlets 233 are defined in one sidewall 23 opposite to the second receiving groove 231. A plurality of water outlets 235 are defined in one of the sidewalls 23 defining the second receiving groove 231, corresponding to the water inlets 233.

The core 30 is a substantially rectangular block, and is fixedly positioned in the receiving space. Four substantially parallel first cooling channels 31 are defined in the core 30. One end of each first cooling channel 31 is communicated with one corresponding water inlet 233, and another end of the first cooling channel 31 is communicated with one corresponding water outlet 235. In other embodiments, some micro-structures may be defined in the core 30 to form corresponding micro-structures on the optical light guiding plate.

The sliding block 50 is a substantially rectangular block. Each sliding block 50 is slidably positioned in one first receiving groove 230, and is positioned adjacent to the edges of the core 30. A height of each sliding block 50 along a direction perpendicular to the bottom wall 21 is greater than that of the core 30, such that the four sliding blocks 50 and the core 30 cooperatively form a molding space 501. A second cooling channel 51 is defined in each sliding block 50, and includes a water inlet end 511 and a water outlet end 513 opposite to the water inlet end 511. The water inlet end 511 and the water outlet end 513 are defined in one sidewall of the sliding block 50 away from the molding space 501. The second cooling channel 51 is U-shaped. In the illustrated embodiment, the second cooling channel 51 does not communicate with the first cooling channel 31, such that the water temperature and a velocity of water flow in the second cooling channel 51 can be adjusted independently. In addition, the second cooling channels 51 are spaced from each other without communicating with each other, such that the water temperature and the velocity of water flow of each second cooling channel 51 can be adjusted conveniently. Thus, the water temperature and the cooling velocity at each edge of the molding product can be adjusted independently.

In alternative embodiments, the number of the sliding blocks 50 can be changed as needed according to the features of the molding products, for example one, or two and others. The number of the second cooling channels 51 corresponds to the number of the sliding blocks 50. The first receiving groove 230 can be defined in other parts of the second mold base 20; for example, the first receiving groove 230 can be defined in a middle portion of the sidewall 23.

The gate inlet block 70 is fixedly mounted in the second receiving groove 231 adjacent to the edges of the sliding block 50 and the core 30. A substantially wedge-shaped gate inlet 71 is defined in the gate inlet block 70. A larger end of the gate inlet 71 is communicated with the molding space 501. When closing the mold 100, a cold slug well 73 is defined in an end of a bottom wall of the gate inlet 71 away from the core 30, and the main channel 11 communicates with the gate inlet 71. A third cooling channel 75 is defined in the gate inlet block 70 around the gate inlet 71, and is not communicated with the first or second cooling channels 31, 51, such that the water temperature and the velocity of water flow of the third cooling channel 75 can be adjusted independently.

In an alterative embodiment, the gate inlet block 70 may be omitted, then the gate inlet 71 is directly defined in the first mold base 10, and the third cooling channel 75 can be omitted.

The mold cooling process will be efficacious and uniform during molding, and the molding product will be formed without warping or warpage because the first cooling channels 31 in the core 30, the second cooling channels 51 in the sliding blocks 50, and the third cooling channel 75 in the gate inlet block 70 can be separately temperature-controlled to produce even cooling effects throughout the mold space 501, which can also safely speed up the cooling process. In the illustrated embodiment, the first, second and third cooling channels 31, 51, 75 are positioned apart from each other, then adjusting the cooling temperature and velocity will be more convenient, and the quality of the molding products will be improved.

It is to be understood, however, that even through numerous characteristics and advantages of the disclosure have been set forth in the foregoing description, together with details of the structure and function of the present disclosure, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A mold, comprising:
a first mold base;
a second mold base engaged with the first mode base;
a core fixedly positioned in the second mold base, the core defining a plurality of first cooling channels therein;
at least one sliding block slidably positioned on the second mold base and adjacent to edges of the core,
wherein the at least one sliding block and the core cooperatively form a molding space, and a second cooling channel is defined in each sliding block.

2. The mold of claim 1, wherein the mold further comprises a gate inlet block positioned on the second mold base and adjacent to edges of the at least one sliding block and the core, a gate inlet is defined in the gate inlet block and communicated with the molding space.

3. The mold of claim 2, wherein a third cooling channel is defined in the gate inlet block.

4. The mold of claim 3, wherein the third cooling channel is defined in the gate inlet block around the gate inlet.

5. The mold of claim 2, wherein the gate inlet is wedge-shaped.

6. The mold of claim 1, wherein the plurality of first cooling channels and the at least one second cooling channel are positioned apart from each other.

7. The mold of claim 1, wherein the at least one second cooling channel is positioned apart from each other.

8. The mold of claim 1, wherein the second mold base comprises a bottom wall and a plurality of side walls extending from edges of the bottom wall, the bottom wall and the side walls cooperatively form a receiving space, and the core is received in the receiving space.

9. The mold of claim 8, wherein a first receiving groove is defined in each sidewall, the number of the sliding blocks corresponds to the number of side walls, and each siding block is received in one corresponding first receiving groove.

10. The mold of claim 9, wherein the mold further comprises a gate inlet block, a gate inlet is defined in the gate inlet block and communicated with the molding space, a second receiving groove is defined in one of the plurality of side walls adjacent to the first receiving groove, the gate inlet block is received in the second receiving groove.

11. The mold of claim 10, wherein a third cooling channel is defined in the gate inlet block, the at least one second cooling channel and the third cooling channel are positioned apart from each other.
